(19) United States
(12) Patent Application Publication
(10) Pub. No.: US 2023/0390999 A1
(43) Pub. Date: Dec. 7, 2023

(54) APPARATUS AND METHOD OF BINDER JETTING 3D PRINTING

(71) Applicant: Sakuu Corporation, San Jose, CA (US)

(72) Inventors: Steven Zhichao SHI, Santa Clara, CA (US); Morteza VATANI, Los Gatos, CA (US)

(73) Assignee: Sakuu Corporation, San Jose, CA (US)

(21) Appl. No.: 17/832,431

(22) Filed: Jun. 3, 2022

(51) Int. Cl. B29C 64/165; B29C 64/245; B29C 64/209; B29C 64/232; B29C 64/236; B29C 64/282; B33Y 10/00; B33Y 30/00

(52) U.S. Cl. CPC B29C 64/165; B29C 64/245; B29C 64/209; B29C 64/232; B29C 64/236; B29C 64/282; B33Y 10/00; B33Y 30/00

(57) ABSTRACT

A 3D printing apparatus and method including a powder distributor, located and configured to deposit powder on an upper surface of a build platform, an inkjet printhead to deliver a binder on the deposited powder, a curing to irradiate the delivered binder with radiation, and a mounting apparatus to mount the printhead and the curing unit, wherein one of the mounting apparatus and the build platform is configured to move in first and second directions, wherein the second direction is opposite the first direction, while the other of the mounting apparatus and the build platform remains stationary, and wherein the powder distributor, the printhead and the curing unit operate in synchronization with one another in response to actuation of the powder distributor to begin distributing powder.

### TECHNICAL FIELD

Various implementations relate to binder jetting 3D printing. More particularly, various implementations relate to binder jetting 3D printing using ultraviolet (UV) curable binders.

### BACKGROUND

Existing binder jetting 3D printing technologies are typically based on deposition of a thermal curing binder on a powder bed. The thermal curing binder is typically cured slowly after the binder is deposited in a powder layer. The printed object formed with such slow thermal curing binder may have to undergo additional post printing curing, e.g. further curing in an oven. In some embodiments, the layer-by-layer fabrication process entails sequentially depositing powder, jetting a slow thermal curing binder, and curing the jetted binder, then repeating the process steps to form a three-dimensional object. Such a process is time consuming, particularly when using a slow thermal curing binder, leading to low productivity. Hence, there is a need for methods to improve the speed of binder jetting 3D printing process.

### SUMMARY

In one general aspect, the instant application describes a 3D printing apparatus including a build platform having an upper surface with a longitudinal axis extending in a longitudinal direction thereof, a powder distributor located and configured to deposit powder on the upper surface of the build platform, an inkjet printhead over the upper surface of the build platform, the inkjet printhead being configured to deliver a binder on the deposited powder, a first curing unit adjacent to the inkjet printhead, the curing unit being configured to irradiate the delivered binder with radiation, and a mounting apparatus configured to mount the inkjet printhead and the curing unit, wherein one of the mounting apparatus and the build platform is configured to move in a first direction, substantially parallel to the longitudinal direction, while the other of the mounting apparatus and the build platform remains stationary, and wherein the powder distributor, the inkjet printhead and the curing unit are configured to operate in synchronization with one another in response to actuation of the powder distributor to begin distributing powder. In another aspect the curing unit comprises a UV curing unit configured to irradiate the delivered binder with UV radiation.

For another example, a method of 3D printing is described, the method including depositing powder on an upper surface of a build platform using a powder distributor, wherein the upper surface has a longitudinal axis extending in a longitudinal direction thereof, delivering a binder on the deposited powder using an inkjet printhead located over the upper surface of the build platform, and irradiating the delivered binder with radiation using a curing unit located over the upper surface of the build platform adjacent to the inkjet printhead, wherein the inkjet printhead and the curing unit are mounted on a mounting apparatus located over the upper surface of the build platform, wherein one of the mounting apparatus and the build platform is configured to move in a first direction, substantially parallel to the longitudinal direction, while the other of the mounting apparatus and the build platform remains stationary, and wherein the powder distributor, the inkjet printhead and the curing unit operate in synchronization with one another in response to actuation of the powder distributor to begin distributing powder. In another aspect, the delivered binder is irradiated with UV radiation using a UV curing unit.

These general and specific aspects may be implemented using a system, a method, or a computer program, or any combination of systems, methods, and computer programs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Additional advantages and novel features of these various implementations will be set forth in part in the description that follows, and in part will become more apparent to those skilled in the art upon examination of the following or upon learning by practice of the invention.

### BRIEF DESCRIPTION OF THE DRAWINGS

The drawing figures depict one or more implementations in accordance with the present teachings, by way of example only, not by way of limitation. In the figures, like reference numerals refer to the same or similar elements. Furthermore, it should be understood that the drawings are not necessarily to scale.

FIGS. 1-8 are illustrations of various stages in a 3D printing apparatus according to various implementations.

FIG. 9 is a flowchart illustrating a method of 3D printing, according to various implementations.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Existing binder jetting 3D printing processes comprise sequential process steps including depositing a powder layer, depositing a liquid binder onto the deposited powder layer, curing the deposited binder, and then repeating these steps to form a printed 3D object. The binder used in the binder jetting 3D printing is typically a slow thermal curing binder, which often requires additional post-printing curing, e.g., further curing in an oven. The sequential process and the use of slow thermal curing binder limit the speed of the binder jetting 3D printing process, thus leading to low productivity. Current binder jetting 3D printing apparatuses and processes typically present a technical problem because of their slow speed of operation. For example, after the deposition of a thermal curing binder onto a deposited powder layer, it takes a time of many seconds (e.g. at least 20 seconds) or up to a minute or more in order to cure the binder deposited in the powder layer. As a printed piece or object is composed of a large number of layers, the overall process of printing the entire object can be very time consuming.

To address this technical problem and more, in an example, this description provides a technical solution for speeding up the binder jetting 3D printing process. A binder jetting 3D printing apparatus and a method is provided in which a powder deposition device or powder distributor, a binder jetting device (e.g., an inkjet printer), and a curing device are configured and operated in such a way that the movement of the powder deposition device is synchronized with the movement of the binder jetting and curing devices. This enables the deposition of a powder layer, the jetting of a binder and cure of the binder by radiation in one single pass, thus greatly increasing the speed of the binder jetting 3D printing process.

In one specific implementation, a binder jetting 3D printing apparatus or system includes UV curing devices which cure the binder using UV radiation. For example, two UV curing heads on each side of a UV curable binder printhead, e.g., an inkjet printhead. Accordingly, when the UV curable binder is deposited on the powder during one pass of the printhead in a given direction, the trailing UV-curing head is able to cure the binder during that pass by applying UV radiation to the UV curable binder that has been deposited in the powder. The same process may be performed in a subsequent pass in an opposite direction to the previous pass. Accordingly, deposition of binder and curing of the binder can be accomplished during the same pass instead of two sequential passes of binder deposition followed by curing. As a result, the overall speed of the binder jetting 3D printing process is substantially increased.

In one specific example, the time required for depositing a powder layer, jetting a binder onto the deposited powder layer and curing the jetted binder is decreased from many seconds (e.g., twenty seconds) or up to a minute or more in a typical binder jetting 3D printing process to a few seconds, e.g., five seconds. In implementations, the time of a single pass operation which includes the deposition of a powder layer, the injection of a UV-curable binder and the application of a UV radiation to cure the UV-curable binder may be greatly reduced to a range of only several seconds, e.g., five seconds. This is made possible by synchronizing the operations of the powder deposition, binder injection and curing, as will be discussed below.

In various implementations, UV curable binder is applied in the binder jetting printing system and process as a substitute to conventional thermal curable binder typically used in the binder jetting printing system and process. For example, the binder jetting 3D printing system using a UV curable binder according to various implementations can include a UV curing device in the binder jetting 3D printing system configured to cure the UV-curable binder that is deposited in a powder layer by inkjet printing by applying UV radiation to the deposited UV-curable binder. As a result, the speed of the powder layer formation and binder curing is substantially increased because there is no need for an additional post-printing curing process, e.g., further curing in an oven. This process removes or reduces the need for a post-printing curing process because the binder is cured during the printing process.

In various implementations, the UV-curable binder is deposited or jetted by an inkjet printhead, and UV curing units located on each side of the inkjet printhead may cure the UV-curable binder immediately after, contemporaneously with, or simultaneously with, the deposition of the UV-curable binder. Accordingly, during each pass of the deposition of the powder and the UV-curable binder by the inkjet printhead, e.g., from left to right, the binder is cured by the UV curing unit located behind, i.e., to the left of, the inkjet printhead in the direction left to right. During the subsequent pass, e.g., from right to left, when the inkjet printhead deposits the UV-curable binder, the other UV curing unit located behind, i.e., to the right of, the inkjet printhead in the direction right to left applies UV radiation to cure the binder. Accordingly, the UV curable binder printing and curing apparatus according to various implementations increases the speed of binder jetting 3D printing systems and processes by, e.g., removing the need for additional post-printing curing process that is typically needed when using a conventional thermal cure binder, e.g., further curing the binder post printing in an oven.

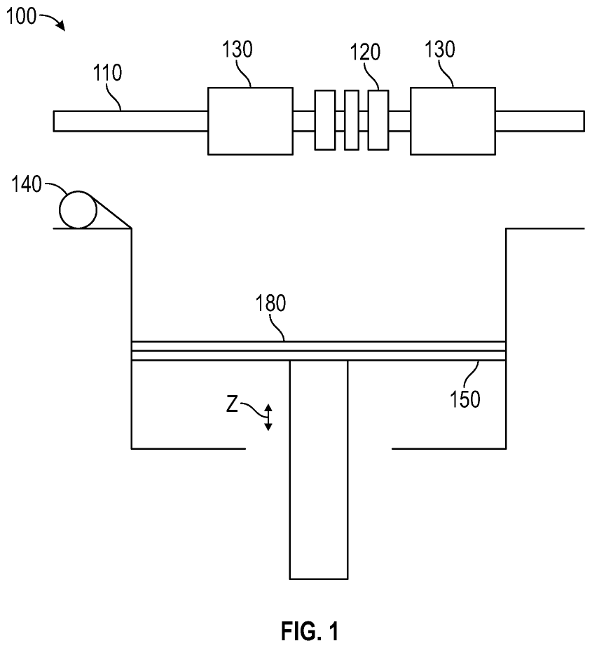

FIGS. 1 to 8 are illustrations of a 3D printing apparatus according to various implementations. In FIG. 1, the binder jetting printing system 100, according to various implementations, includes a build platform 150 upon which the printed piece or manufactured part is built, specifically upon which the powder 180 is deposited during the 3D printing process. The build platform 150 has an upper surface with a longitudinal axis extending in a longitudinal direction thereof. In some implementations, the build platform 150 may comprise a substrate, a carrier substrate, an assembly plate, conveyor belt or conveyorized printing platform, for example. The binder jetting printing system 100 further includes a powder distributor 140 adjacent the build platform 150 and configured to distribute or apply the powder 180 one layer at a time over the build platform 150, e.g., one layer that is 100 μm thick at a time, or to deposit the powder 180 one layer at a time over previously deposited layers. For example, in FIG. 1, the powder distributor 140 performs one pass from left to right and deposits one layer of powder 180. Once binder jetting or printing has taken place on that deposited powder layer, the powder distributor 140 may perform another pass, from right to left, to deposit another powder layer. Accordingly, the location of the powder distributor 140 that is illustrated in FIG. 1, together with the thickness of the powder 180 that has been deposited, may correspond to the powder distributor 140 having completed one cycle of powder deposition from left to right and then from right to left, during which two (2) layers of powder 180 have been deposited.

In various implementations, the binder jetting printing system 100 further includes one or more inkjet printheads 120 located on an X-Y positioning system 110, also referred to as mounting apparatus. The inkjet printheads 120 are over the upper surface of the build platform 150, and are configured to deliver a binder on the deposited powder. The binder may be cured using one or more radiant energy or radiation sources selected from the group including thermal radiation, electromagnetic waves, infrared (IR) radiation, ultraviolet (UV) radiation, visible light, microwave radiation, and electron beam, etc. In one example, the mounting apparatus or X-Y positioning system 110 is configured to control the movement of the inkjet printheads, via a controller (not shown), either from right to left, or from left to right along the longitudinal axis formed by the X-Y positioning system 110, in order to deposit the UV-curable binder on the deposited powder 180. Alternatively, the X-Y positioning system 110 is configured to control the movement of the inkjet printheads in a direction, substantially perpendicular to the longitudinal axis formed by the X-Y positioning system 110, in order to deposit the UV-curable binder on the deposited powder 180.

In some embodiments, one of the mounting apparatus 110 and the build platform 150 is configured to move in first and second directions, wherein the second direction is opposite the first direction, substantially parallel to the longitudinal direction, while the other of the mounting apparatus 110 and the build platform 150 remains stationary. The binder jetting printing system 100 also includes at least two (2) curing units, for example UV curing units 130, each of the UV curing units 130 being located adjacent to, or on each side of, the one or more inkjet printheads 120 on the X-Y positioning system 110 and along the longitudinal axis formed by the X-Y positioning system 110. The UV curing units 130 are configured to move behind the movement of at least one of the inkjet printheads 120. In some implementations, the powder distributor 140, the inkjet printhead 120, and the UV-curing units 130 may be configured to move in first and second directions with respect to the build platform 150 in a longitudinal direction parallel to the longitudinal axis formed by the X-Y positioning system 110, while the build platform 150 may remain static in a direction parallel to the longitudinal direction. In other implementations, the powder distributor 140, the inkjet printhead 120, and the UV-curing units 130 may remain static in the longitudinal direction, while the build platform 150 may be movable with respect to the powder distributor 140, the inkjet printhead 120, and the UV-curing units 130 in a longitudinal direction parallel to the longitudinal axis formed by the X-Y positioning system 110. In all cases, the operations of the powder distributor 140, the inkjet printhead 120, and the UV-curing units 130 are synchronized with one another in order to optimize and speed up the overall printing operation.

In various implementations, the curing units, for example UV curing units 130, may be configured to irradiate the binder delivered by the inkjet printheads 120 with UV radiation. In implementations, the X-Y positioning system 110, the inkjet printheads 120 and the UV curing units 130 are movable together in a synchronized manner. Alternatively, the X-Y positioning system 110 is static while the printheads 120 and the UV curing units 130 are movable. In other implementations, either one of, or all of, the powder distributor, the inkjet printhead, the curing units and the build platform are configured to move in a first direction parallel to the longitudinal direction and in a second direction, the second direction being a reverse of the first direction. For example, in FIG. 1, any one of the powder distributor, the inkjet printhead, the curing units and the build platform are configured to move from left to right in the figure, and from right to left.

In implementations, the powder distributor 140, the inkjet printheads 120 and the curing units, for example UV curing units 130, are configured to operate in synchronization with one another in response to actuation of the powder distributor 140 to begin distributing powder on the upper surface of the build platform 150. In other words, once the powder distributor 140 is actuated by a controller (not shown) to begin distributing powder, the activations, durations and/or the speeds of the movements of powder distributor 140, the inkjet printhead 120 and the UV curing units 130, are also controlled in a synchronized manner to coordinate their respective operations. As will also be described further herein regarding alternative implementations, if more than one powder distributor is utilized, then the operations of these multiple powder distributors are also synchronized to optimize and speed up the overall printing operation.

In the example illustrated in FIG. 1, no printed piece has yet been formed and only one or more layers of powder 180 have been deposited on the build platform 150. The binder jetting printing system 100 may also include a movable shaft controlled by the controller (not shown) and configured to move the build platform 150 in a direction Z, substantially perpendicular to the longitudinal axis formed by the X-Y positioning system 110. In other embodiments, the binder jetting printing system may be configured to move in a direction Z, substantially perpendicular to the longitudinal axis formed by the build platform 150.

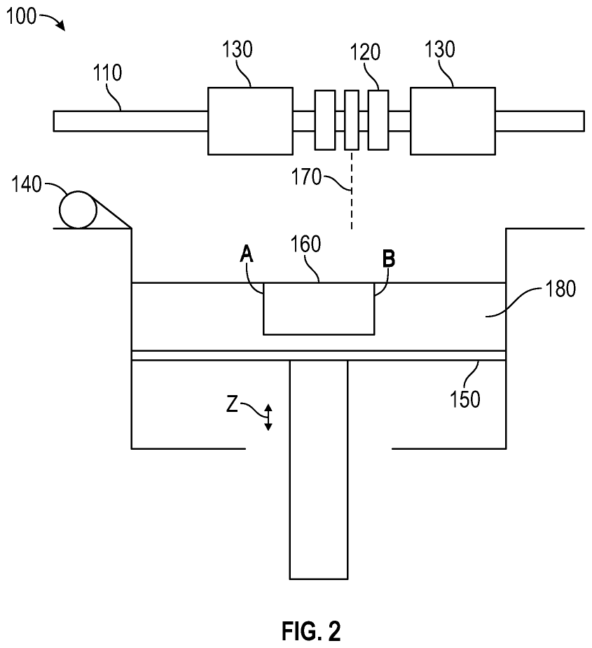

FIG. 2 illustrates a later stage in the 3D printing process, implemented in this example using a UV-curable binder. In operation, the powder distributor 140 performs a plurality of successive passes, from left to right and then from right to left, over the build platform 150, to deposit the powder 180, and the inkjet printhead 120 deposits the UV-curable binder 170, during each of the passes and at specific locations to form the printed piece 160. For example, after a layer of powder has been deposited, the inkjet printhead 120 deposits the UV-curable binder 170 only when the inkjet printhead 120 is located at a particular position, the particular position corresponding to a cross-section of the printed piece 160, the cross-section corresponding to the dimensions of the printed piece 160. In implementations, the inkjet printhead 120 only deposits the UV-curable binder 170 when the X-Y positioning system 110 determines that the inkjet printhead 120 is between locations A and B illustrated in FIG. 2, either during a left-to-right pass or a right-to-left pass. For example, the distance between locations A and B corresponds to a cross-section of the piece 160 to be printed. When the X-Y positioning system 110 determines that the inkjet printhead 120 is not between locations A and B illustrated in FIG. 2, then the inkjet printhead 120 does not deposit any UV-curable binder 170 on the powder 180. Accordingly, when the inkjet printhead 120 is between locations A and B the inkjet printhead 120 deposits the UV-curable binder 170, which is cured, e.g., immediately after being deposited, by one of the UV curing units 130 that trails the inkjet printhead 120 in the direction of movement of the inkjet printhead 120 during that same pass, i.e., from left to right or from right to left. More specifically, when the inkjet printhead 120 moves from left to right in FIG. 2 and the controller determines that the inkjet printhead 120 is at position A then the inkjet printhead 120 starts depositing the UV-curable binder 170. During that same pass, immediately after the inkjet printhead 120 has deposited the UV-curable binder 170, the UV curing unit 130 that is to the left of the inkjet printhead 120 applies UV radiation to cure the just-deposited UV-curable binder. As a result, over a plurality of left-to-right and right-to-left passes of the inkjet printhead 120, the printed piece 160 starts to be formed layer by layer, as illustrated in FIG. 2.

In various implementations, the X-Y positioning system 110 includes the controller (not shown) that receives the coordinates of the inkjet printhead 120. The controller is configured to control delivery of the UV-curable binder 170 via the inkjet printhead 120. For example, when the X-Y positioning system 110 indicates that the inkjet printhead 120 is at specific locations that correspond to the cross-section of the piece to be printed, the controller instructs the inkjet printhead 120 to deliver the UV-curable binder 170. In contrast, when the X-Y positioning system 110 indicates that the inkjet printhead 120 is at a location that is outside the cross-section of the piece to be printed, as discussed above with respect to locations A and B for example, the controller instructs the inkjet printhead 120 not to deliver the UV-curable binder 170.

In various implementations, the powder distributor 140 and the inkjet printhead 120 may be configured so that the movement of the powder distributor 140 is synchronized via, for example, the controller, with the movements of the inkjet printhead 120 and the UV curing units 130. Accordingly, the deposition of a powder layer 180 may take place during a single pass, which corresponds to a travel of the inkjet printhead 120 and the UV curing units 130 from left to right (or right to left) because the jetting of the UV-curable binder 170 and the curing of the binder 170 by UV radiation may be performed during the same pass. As a result, the speed of printing can be greatly increased. To illustrate, it may not be necessary that the deposition of the powder layer 180 is completed on an entire layer before the UV-curable binder 170 can be deposited. Similarly, it may not be necessary that the binder deposition be completed on the entire layer before the curing process is initiated. For example, the deposition of the powder layer 180 and the jetting and curing of the UV-curable binder 170 may be synchronized by adjusting the speeds of the movements of powder distributor 140, the inkjet printhead 120 and the UV curing units 130. In one implementation, the speeds of the movements of powder distributor 140, inkjet printhead 120 and the UV curing units 130 can be different, and can be adjusted individually.

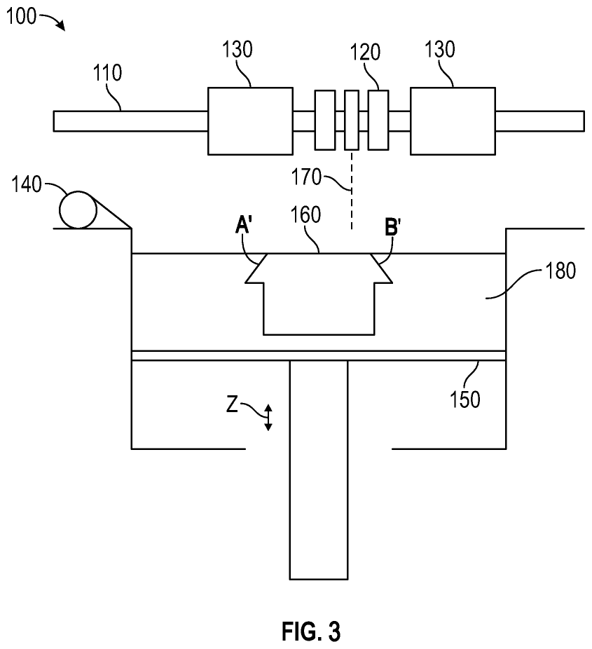

FIG. 3 illustrates a later stage of 3D printing, where a plurality of additional passes have been accomplished by the powder distributor 140, the inkjet printhead 120 and the UV curing units 130, and as a result a plurality of additional layers of powder have been deposited and a plurality of layers of the piece 160 have been printed. For example, the inkjet printhead 120 continues to deposit the UV-curable binder 170 when the inkjet printhead 120 is between specific locations corresponding to cross-sections of the piece 160 to be printed. The specific locations may vary based on the varying cross-section of the piece 160 to be printed. For example, FIG. 3 illustrates a deposition process where the inkjet printhead 120 deposits the UV-curable binder 170 only when the inkjet printhead 120 is between locations A′ and B′, these locations being different from the locations A and B discussed earlier with respect to FIG. 2 because the cross-section of the printed piece 160 changes as its thickness increases.

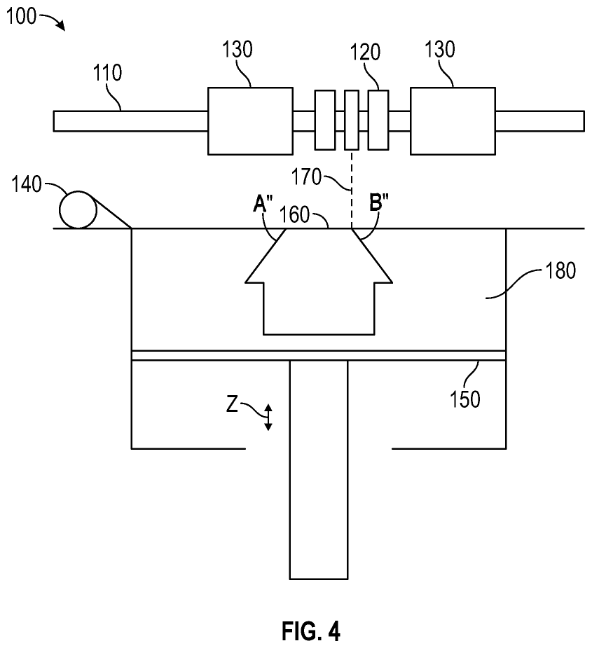

FIG. 4 illustrates an even later stage of 3D printing, where a plurality of additional passes have been accomplished by the powder distributor 140, the inkjet printhead 120 and the UV curing units 130, and where the printed piece 160 is almost complete. For example, the inkjet printhead 120 continues to deposit the UV-curable binder 170 when the inkjet printhead 120 is between specific locations corresponding to cross-sections of the printed piece 160. The specific locations may vary as the cross-section of the printed piece 160 varies during the printing process of the piece 160. For example, FIG. 4 illustrates a deposition process where the inkjet printhead 120 deposits the UV-curable binder 170 only when the inkjet printhead 120 is between locations A″ and B″, these locations being different from the locations A and B, and A′ and B′, discussed earlier with respect to FIGS. 2 and 3, respectively, because the cross-section of the printed piece 160 changes as its thickness increases. In implementations, the time of a single pass which includes the deposition of a single powder layer, the injection of the UV-curable binder and the application of UV radiation to cure the UV-curable binder may be in a range of only several seconds, e.g. five seconds.

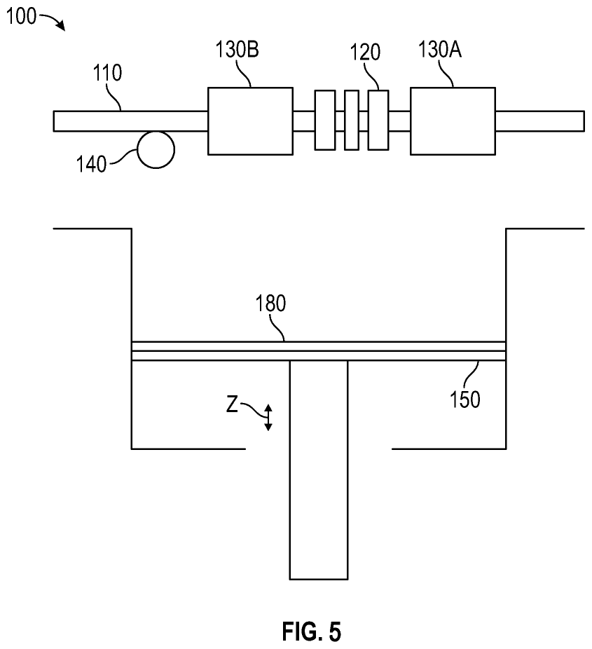

FIG. 5 is an illustration of a 3D printing apparatus according to various implementations. In FIG. 5, the powder distributor 140 is mounted on the mounting apparatus or X-Y positioning system 110. The binder jetting printing system 100 includes the powder distributor 140 configured to distribute or apply the powder 180 one layer at a time. In this implementation, the powder distributor 140 is located adjacent to the inkjet printhead 120 and the UV curing units 130A and 130B along the axis of the X-Y positioning system 110. The binder jetting printing system 100 further includes the build platform 150 upon which a printed piece or manufactured part is built via the 3D printing process.

The powder distributor 140 may be integrated with the inkjet printhead 120 and the UV curing units 130A and 130B along the axis of the X-Y positioning system 110. As a result of this configuration, the deposition of a layer of the powder 180, the jetting of a UV-curable binder, and the curing of the jetted binder by one of the UV curing units 130, may be performed during a same pass, which may significantly increase the speed of printing. Specifically, as the powder distributor 140 distributes powder 180 on the build platform 150 during a single pass, for example from right to left in FIG. 5, the inkjet printhead 120, which is behind the powder distributor 140 in the direction of movement of the powder distributor 140, may deposit the UV-curable binder 170 on the deposited powder 180 that has just been deposited by the powder distributor 140. In addition, during the same pass, the UV-curing unit 130A, which is behind the inkjet printhead 120 in the direction of movement of the inkjet printhead 120, cures the just-deposited binder 170 by emitting UV radiation thereon. During this same pass, the UV-curing unit 130B that is in front of the inkjet printhead 120 in the direction of movement of the inkjet printhead 120 may be turned off or deactivated to not emit any UV radiation. For achieving additional cure, the UV-curing unit 130B may be turned on when it moves in the opposite direction.

In implementations, the integrated arrangement consisting of the powder distributor 140, the inkjet printhead 120, and the UV-curing unit 130 is movable with respect to the build platform 150 in a longitudinal direction parallel to the longitudinal axis formed by the X-Y positioning system 110, while the build platform 150 may remain static in a direction parallel to the longitudinal direction. In other implementations, the integrated arrangement consisting of the powder distributor 140, the inkjet printhead 120, and the UV-curing unit 130 may be static in the longitudinal direction, while the build platform 150 may be movable with respect to the integrated arrangement in the longitudinal direction. In other implementations, both the integrated arrangement consisting of the powder distributor 140, the inkjet printhead 120 and the UV-curing unit 130, and the build platform 150 are movable with respect to each other in directions parallel to the longitudinal direction.

The powder distributor 140 may be configured to deposit a single powder, or a plurality of powders contemporaneously, simultaneously or sequentially. For example, the powder distributor 140 may include a plurality of powder distributors (not shown), each distributor being configured to deposit the same or a different powder.

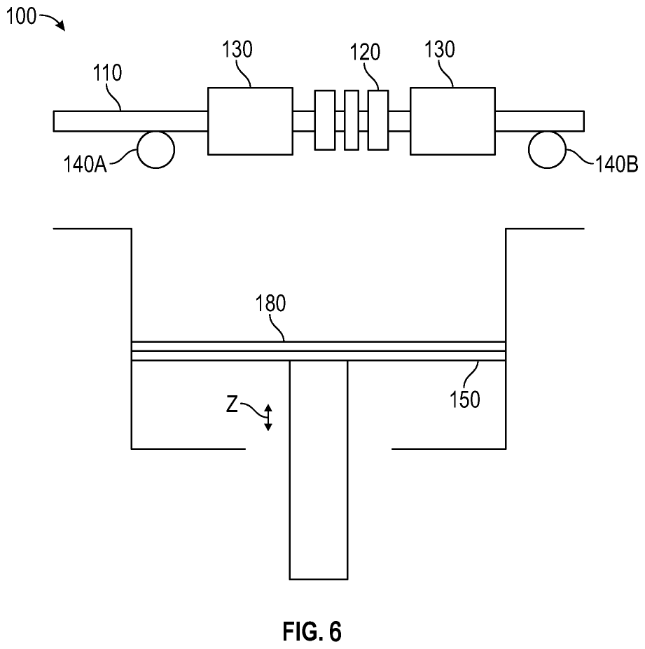

FIG. 6 is an illustration of a 3D printing apparatus according to various implementations. In FIG. 6, the binder jetting printing system 100 includes an integrated arrangement comprising a first powder distributor 140A and a second powder distributor 140B. The first powder distributor 140A may be configured to distribute or apply the powder 180 on the build platform 150. The first powder distributor 140A may be located adjacent to, and on one side, e.g. the left side of the inkjet printhead 120 and the UV curing units 130 along the axis of the X-Y positioning system 110. The second powder distributor 140B may be adjacent to and on an opposite side, e.g. right side of the inkjet printhead 120 and the UV curing units 130 along the axis of the X-Y positioning system 110 from the first powder distributor 140A. The second powder distributor 140B may also be configured to distribute or apply the powder 180 on the build platform 150.

Due to the above printing arrangement having two powder distributors 140A and 140B, a powder 180 can be deposited on the build platform 150 during each pass of the printing arrangement, i.e., from left to right or from right to left as illustrated in FIG. 6. For example, a layer of powder 180 may be deposited when the printing arrangement consisting of the powder distributors 140A/140B, the inkjet printhead 120 and the UV-curing units 130 moves from left to right, and also when the printing arrangement moves from right to left. During each pass, one of the powder distributors 140A/140B deposits a layer of powder 180, and the inkjet printhead 120, which is located behind the powder distributor 140A/140B in the direction of movement thereof, deposits a UV-curable binder. One of the UV-curing units 130 that is behind the inkjet printhead 120 in the direction of movement of the printing arrangement cures the deposited binder by emitting UV radiation thereon. As a result, powder deposition may take place during each pass, in both directions from left to right and from right to left, the printing speed may thus be greatly increased. The build platform 150 may be stationary, or may be movable in a direction parallel to the longitudinal direction of the axis formed by the X-Y positioning system 110.

In various implementations, each of the two powder distributors 140A and 140B may also be configured to deposit a powder of the same material or a different material than the other. In some implementations, one of the powder distributors 140A and 140B may deposit a powder of a first material during a first pass, e.g., from left to right in FIG. 6, and the other of the powder distributors 140A and 140B may deposit a powder of a second material in a successive pass, e.g., from right to left in FIG. 6. Alternatively, during a single pass, one of the powder distributors 140A and 140B may deposit a powder of a first material, and the other of the powder distributors 140A and 140B may deposit a powder of a different material during the same pass.

The deposition of the powder 180 by both powder distributors 140A and 140B may be synchronized so that, for example, the powder distributor 140A deposits the powder 180 when the printing arrangement travels from right to left, and the powder distributor 140B deposits the powder 180 when the printing arrangement travels from left to right. In some implementations, the specific location of the printing arrangement that consists of the powder distributors 140A/140B, the inkjet printhead 120 and the UV-curing units 130 may be controlled by a controller (not shown) which instructs which of the two powder distributors 140A or 140B deposits the powder 180 on the build platform 150 and for how long during the deposition process. In other implementations, the deposition of the powder 180 by both powder distributors 140A and 140B may be synchronized so that, for example, the powder distributor 140A deposits a first powder at a given time, and the powder distributor 140B may deposit a second powder at a second time, during the same pass or during different passes, the second power being the same as or different than the first powder.

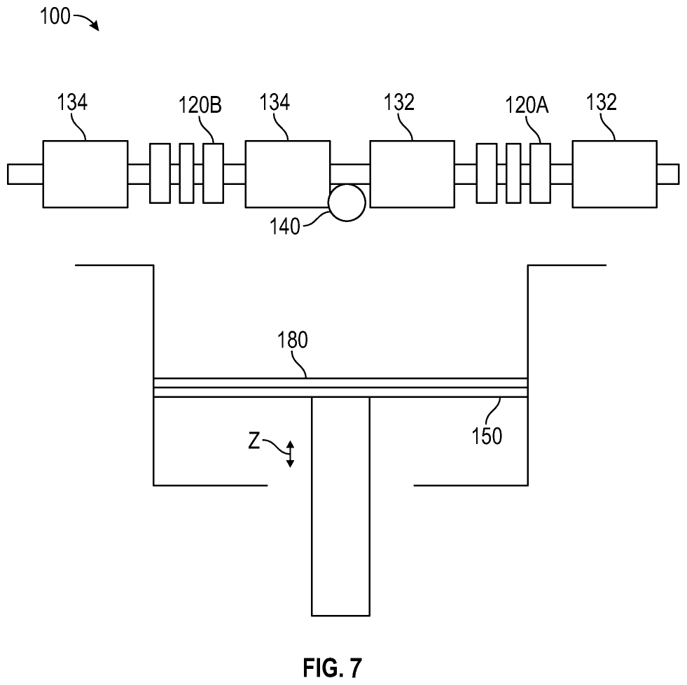

FIG. 7 is an illustration of a 3D printing apparatus according to various implementations. In FIG. 7, the binder jetting printing system 100 includes a powder distributor 140 configured to distribute or apply the powder 180 over the build platform 150. In this scenario, the binder jetting printing system 100 includes two (2) binder printing/curing arrangements, namely a first binder printing/curing arrangement consisting of inkjet printhead 120A and UV-curing units 132, and a second binder printing/curing arrangement consisting of inkjet printhead 120B and UV-curing units 134, with the powder distributor 140 located between the two binder printing/curing arrangements along the axis of the X-Y positioning system 110. As an example of operation, the powder distributor 140 performs one pass from left to right in FIG. 7 and deposits a layer of powder 180 on the build platform 150. During the same pass, the inkjet printhead 120B, which is behind the powder distributor 140 in the direction of movement, deposits the UV-curable binder 170, and the UV-curing unit 134, which is behind the inkjet printhead 120B in the direction of movement, cures the deposited UV-curable binder 170 by emitting UV radiation thereon. On the subsequent pass, i.e., from right to left, the powder distributor 140 deposits another layer of powder 180 on the build platform, the other inkjet printhead 120A, which is behind the powder distributor 140 in the direction of movement, deposits the UV-curable binder 170, and the UV-curing unit 132, which is behind the inkjet printhead 120A in the direction of movement, cures the deposited UV-curable binder 170 by emitting UV radiation thereon. Accordingly, FIG. 7 illustrates a binder jetting printing system that allows printing of the powder in both directions of movement of the powder distributor 140, i.e., from right to left and from left to right along the axis of the X-Y positioning system 110, thus increasing printing speed.

In various implementations, the powder distributor 140 may include more than one powder distributors, each distributor being configured to deposit a different type of powder materials. Accordingly, one powder material may be deposited during a given pass of the binder jetting printing system, i.e., from left to right, via a first powder distributor, and another powder material may be deposited during a subsequent pass of the binder jetting printing system, i.e., from right to left, via a second distributor. Alternatively, the powder distributor 140 may be configured to deposit a first powder at a first time, and another powder at a second time, during the same pass of the binder jetting printing system. The powder distributor 140 may be configured to deposit a first powder when at a first location, and another powder when at a different location, during the same pass of the binder jetting printing system. Although the build platform 150 is illustrated as being static, the build platform 150 may also travel in a direction parallel to the longitudinal axis of the X-Y positioning system 110.

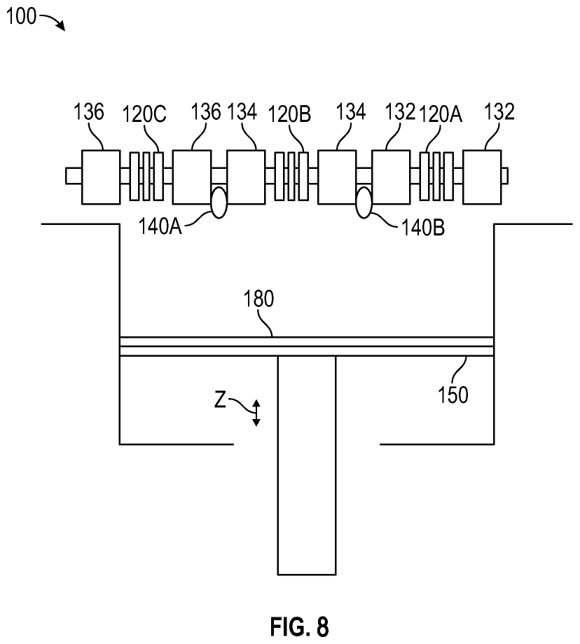

FIG. 8 is an illustration of a 3D printing apparatus according to various implementations. In FIG. 8, the binder jetting printing system 100 includes three (3) binder printing/curing arrangements, each including an inkjet printhead and UV-curing units, with powder distributors 140A and 140B between the binder printing/curing arrangements. Specifically, the binder jetting printing system 100 includes a first inkjet printhead 120A and two UV-curing units 132 on each side of the inkjet printhead 120A in a longitudinal direction of the axis formed by the X-Y positioning system 110. The binder jetting printing system 100 also includes a second inkjet printhead 120B and two UV-curing units 134 on each side thereof, and a third inkjet printhead 120C and two UV-curing units 136 on each side thereof. Accordingly, during a single pass, both powder distributors 140A and 140B may deposit powder on the build platform 150. For example, each of the powder distributors 140A and 140B may deposit the same or a different powder material.

In various implementations of operation, during a first pass, e.g., from right to left as illustrated in FIG. 8, the first powder distributor 140A may first deposit a first powder, inkjet printhead 120B may then deposit a UV-curable binder, and the UV-curing unit 134 that is behind the inkjet printhead 120B in the direction of movement thereof may cure the deposited binder by applying UV radiation on the binder. During the same pass, the second powder distributor 140B may then deposit a second powder, which may be the same or different from the first powder, inkjet printhead 120A may then deposit a UV-curable binder, and the UV-curing unit 132 that is behind the inkjet printhead 120A in the direction of movement thereof may cure the deposited binder.

After the first pass discussed above, during the subsequent pass from left to right, the second powder distributor 140B may first deposit the second powder, the inkjet printhead 120B may then deposit a UV-curable binder, and the UV-curing unit 134 that is behind the inkjet printhead 120B in the direction of movement thereof may cure the deposited binder. Also, during the same pass, the first powder distributor 140A may then deposit the first powder, the inkjet printhead 120C may then deposit a UV-curable binder, and the UV-curing unit 136 that is behind the inkjet printhead 120C in the direction of movement thereof may cure the deposited binder.

Although FIG. 8 illustrates a binder jetting printing system including two (2) powder distributors and three (3) binder printing/curing arrangements, the binder jetting printing system 100 may include more than two (2) powder distributors and more than three (3) binder printing/curing arrangements, as long as any two adjacent binder printing/curing arrangements are separated by a powder distributor. As a result, several layers of powder may be deposited on top of one another on the build platform 150 during any single pass, which may substantially increase the printing speed. In implementations, although the build platform 150 is illustrated as being static, the build platform 150 may also travel in a direction parallel to the axis of the X-Y positioning system 110.

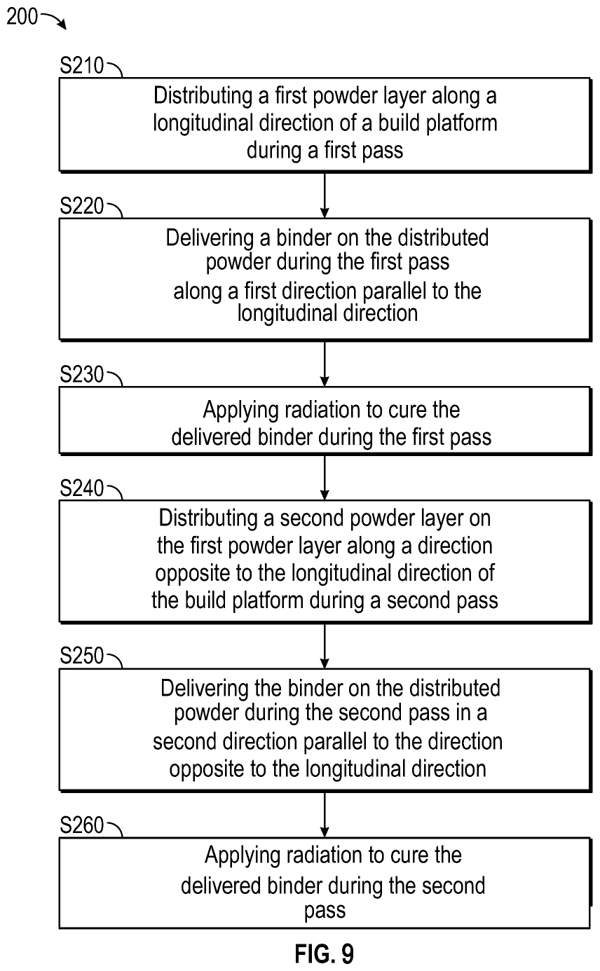

FIG. 9 is a flowchart illustrating a method of 3D printing, according to various implementations. In various implementations, the method 200 starts at S210, where a first powder layer is dispensed, deposited, or distributed on an upper surface of a build platform, or on a previous powder layer, along a longitudinal axis extending in a longitudinal direction of the build platform during a first pass in first and second directions, and the second direction is opposite the first direction and is substantially parallel to the longitudinal direction. With reference to FIG. 1, the powder 180 is deposited or distributed on the build platform 150, e.g., from left to right. In S220, the method continues and includes delivering (for example, injecting or dispensing) a binder, e.g., a UV curable binder, on the dispensed first powder layer during the first pass. With reference to FIG. 2, for example, the inkjet printhead 120 injects UV-curable binder 170 onto the first powder layer. Injecting the UV-curable binder 170 in S220 may include monitoring a position of the inkjet printhead along the longitudinal direction and/or in the direction perpendicular to the longitudinal direction, and injecting the UV-curable binder via an inkjet printhead only when the position of the inkjet printhead is at one or more desired positions. For example, the desired positions may correspond to cross-sections of the piece to be printed. With reference to FIG. 2, the position of the inkjet printhead 120 is monitored, and when the inkjet printhead 120 is between one or more desired position, e.g., positions A and B the inkjet printhead 120 injects UV-curable binder 170 onto the first powder layer. In addition, when the inkjet printhead 120 is outside of positions A and B the inkjet printhead 120 does not inject UV-curable binder 170 onto the first powder layer. Accordingly, as positions A and B define a cross-section of a 3D piece to be printed, the only portion of the powder that receives the UV-curable binder is the portion that corresponds to the shape of the eventual 3D piece to be printed.

In S230, the method 200 continues and includes applying a radiant energy or radiation, for example UV radiation, to cure the injected binder, during the first pass immediately after, or contemporaneously with, the deposition of the binder during S220. For example, depositing the first powder layer and injecting the UV-curable binder are synchronized with one another during the first pass. With reference to FIG. 2, one of the two UV curing units 130 that is behind the inkjet printhead 120 in the direction of the first pass, e.g., in the direction of the deposition of the first powder layer applies UV radiation to the UV-curable binder that has been deposited on the powder layer during S220, which cures the UV-curable binder. Specifically, with respect to FIG. 2, if the deposition of the first powder layer takes place from left to right, then the UV curing unit 130 that is to the left of the inkjet printhead 120 applies the UV radiation to the UV-curable binder 170 that was just deposited by the inkjet printhead 120.

In various implementations, method 200 continues and includes S240, where a second powder layer is deposited or distributed on the first powder layer along the second direction during a second pass. With reference to FIG. 1, a second layer of the powder 180 is deposited on first deposited layer from right to left. In S250, the method 200 continues and includes injecting a curable binder on the deposited second powder layer during the second pass. With reference to FIG. 2, the inkjet printhead 120 injects UV-curable binder 170 onto the second powder layer. In S260, the method 200 continues and includes applying radiation, for example UV radiation, to cure the injected binder during the second pass immediately after, or contemporaneously with, the deposition of the binder during S250. For example, depositing the second powder layer and injecting the binder are synchronized with one another during the second pass. With reference to FIG. 2, one of the two UV curing units 130 that is behind the inkjet printhead 120 in the direction of the second pass, i.e., the direction of the deposition of the second powder layer applies UV radiation to the UV-curable binder that has been deposited on the second powder layer during S250, which cures the UV-curable binder. Specifically, with respect to FIG. 2, if the deposition of the second powder layer takes place from right to left, then the UV curing unit 130 that is to the right of the inkjet printhead 120 applies the UV radiation to the UV-curable binder that was just deposited by the inkjet printhead 120.

In various implementations, each layer of the powder undergoes the process described in the above steps S210-S260, and for each layer, the respective positions determining where to inject and cure the binder, which defines the cross-section of the 3D piece to be printed, may vary to form the eventual 3D piece. As illustrated in FIGS. 2 to 4, the respective positions determining where to inject and cure the UV-curable binder are A to B, A′ to B′ and A″ to B″, respectively, and each successive cross-section defines the dimensions of the eventual piece to be printed for that layer.

In the following, further features, characteristics and advantages of the instant application will be described via the following items:

Item 1: A 3D printing apparatus including a build platform having an upper surface with a longitudinal axis extending in a longitudinal direction thereof, a powder distributor located and configured to deposit powder on the upper surface of the build platform, an inkjet printhead over the upper surface of the build platform, the inkjet printhead being configured to deliver a binder on the deposited powder, a first curing unit adjacent to the inkjet printhead, the first curing unit being configured to irradiate the delivered binder with radiation, and a mounting apparatus configured to mount the inkjet printhead and the first curing unit, wherein one of the mounting apparatus and the build platform is configured to move in a first direction, substantially parallel to the longitudinal direction, while the other of the mounting apparatus and the build platform remains stationary, and wherein the powder distributor, the inkjet printhead and the first curing unit are configured to operate in synchronization with one another in response to actuation of the powder distributor to begin distributing powder.

Item 2: The printer of item 1, wherein the first curing unit comprises a first UV curing unit configured to irradiate the delivered binder with UV radiation.

Item 3: The printer of item 1 or 2, wherein one of the mounting apparatus and the build platform is further configured to move in a second direction, and the second direction is opposite to the first direction.

Item 4: The printer of any of items 1-3, wherein the one of the mounting apparatus and the build platform is further configured to move initially in the first direction and subsequently in the second direction in a synchronized manner in response to actuation of the powder distributor.

Item 5: The printer of any of items 1-4, further including a second curing unit mounted on the mounting apparatus adjacent to the inkjet printhead opposite the first curing unit.

Item 6: The printer of any of items 1-5, wherein the inkjet printhead comprises a UV-curable binder.

Item 7: The printer of any of items 1-6, wherein the inkjet printhead is configured to deposit the UV-curable binder based on a position thereof along the first direction.

Item 8: The printer of any of items 1-7, wherein the powder distributor is mounted on the mounting apparatus adjacent to the inkjet printhead.

Item 9: The printer of any of items 1-8, wherein two powder distributors are mounted on the mounting apparatus adjacent to the inkjet printhead, the inkjet printhead being between the two powder distributers on the mounting apparatus.

Item 10: The printer of any of items 1-9, further including a second inkjet printhead, wherein the powder distributor is between the first inkjet printhead and the second inkjet printhead

Item 11: The printer of any of items 1-10, further including a third inkjet printhead adjacent the second curing unit, and a second powder distributor between the second inkjet printhead and the third inkjet printhead.

Item 12: The printer of any of items 1-11, further including a movable shaft configured to move the build platform in a third direction perpendicular to the longitudinal direction.

Item 13: The printer of any of items 1-12, further including a controller configured to synchronize locations of the powder distributor, the inkjet printhead, and the curing unit.

Item 14: The printer of any of items 1-13, wherein the controller is configured to synchronize the locations of the powder distributor, the inkjet printhead, and the curing unit by varying speed of movements of the powder distributor, the inkjet printhead, and the curing unit to provide adequate time for each of the powder distributor, the inkjet printhead, and the curing unit to perform their respective operations of depositing powder, delivering binder and irradiating the delivered binder in synchronization with one another.

Item 15: A method of manufacturing a three-dimensional object, including depositing powder on an upper surface of a build platform using a powder distributor, wherein the upper surface has a longitudinal axis extending in a longitudinal direction thereof, delivering a binder on the deposited powder using an inkjet printhead located over the upper surface of the build platform, and irradiating the delivered binder with radiation using a curing unit located over the upper surface of the build platform adjacent to the inkjet printhead, wherein the inkjet printhead and the curing unit are mounted on a mounting apparatus located over the upper surface of the build platform, wherein one of the mounting apparatus and the build platform is configured to move in a first direction, substantially parallel to the longitudinal direction, while the other of the mounting apparatus and the build platform remains stationary, and wherein the powder distributor, the inkjet printhead and the curing unit operate in synchronization with one another in response to actuation of the powder distributor to begin distributing powder.

Item 16: The method of item 15, further including wherein one of the mounting apparatus and the build platform is further configured to move in a second direction, and the second direction is opposite to the first direction.

Item 17: The method of item 15 or 16, wherein the one of the mounting apparatus and the build platform is further configured to move initially in the first direction and subsequently in the second direction in a synchronized manner in response to actuation of the powder distributor.

Item 18: The method of any of items 15-17, wherein the delivered binder is irradiated with UV radiation using a UV curing unit.

Item 19: The method of any of items 15-18, further including depositing a first layer of the powder when the one of the mounting apparatus and the build platform moves in the first direction, and depositing a second layer of the powder when the one of the mounting apparatus and the build platform moves in the second direction, after the first layer of powder has been deposited, wherein the powder distributor, the inkjet printhead and the curing unit operate in synchronization with one another in response to actuation of the powder distributor to begin distributing both the first layer of powder in the first direction and the second layer of powder in the second direction.

Item 20: The method of any of items 15-19, wherein the first layer of powder is comprised of a first type material and the second layer of powder is comprised of a second type material, different from the first type material.

Item 21: The method of any of items 15-20, wherein the powder distributor is separate from the mounting apparatus and is configured to move in the first and second directions and to distribute powder in the first and second directions, separate from, and synchronized with, movement of the one of the mounting apparatus and the building platform in the first and second directions.

Item 22: The method of any of items 15-21, wherein the building platform is a conveyorized printing platform configured to move in the first and second directions while the mounting apparatus remains stationary.

Item 23: The method of any of items 15-22, wherein the mounting apparatus is configured to move in the first and second directions while the building platform remains stationary.

Item 24: The method of any of items 15-23, wherein the one of the mounting apparatus and the build platform that is configured to move in the first and second directions is further configured to move with varying speeds for synchronizing operations of the powder distributor, the printhead and the curing unit in response to actuation of the powder distributor to begin distributing powder.

While various embodiments have been described and illustrated, the description and illustrations are intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A 3D printing apparatus comprising:
a build platform having an upper surface with a longitudinal axis extending in a longitudinal direction thereof;
a powder distributor located and configured to deposit powder on the upper surface of the build platform;
an inkjet printhead over the upper surface of the build platform, the inkjet printhead being configured to deliver a binder on the deposited powder;
a first curing unit adjacent to the inkjet printhead, the first curing unit being configured to irradiate the delivered binder with radiation; and
a mounting apparatus configured to mount the inkjet printhead and the first curing unit;
wherein one of the mounting apparatus and the build platform is configured to move in a first direction, substantially parallel to the longitudinal direction, while the other of the mounting apparatus and the build platform remains stationary, and
wherein the powder distributor, the inkjet printhead and the first curing unit are configured to operate in synchronization with one another in response to actuation of the powder distributor to begin distributing powder.

2. The 3D printing apparatus of claim 1, wherein the first curing unit comprises a first UV curing unit configured to irradiate the delivered binder with UV radiation.

3. The 3D printing apparatus of claim 1, wherein one of the mounting apparatus and the build platform is further configured to move in a second direction, and the second direction is opposite to the first direction.

4. The 3D printing apparatus of claim 3, wherein the one of the mounting apparatus and the build platform is further configured to move initially in the first direction and subsequently in the second direction in a synchronized manner in response to actuation of the powder distributor.

5. The 3D printing apparatus of claim 3, further comprising a second curing unit mounted on the mounting apparatus adjacent to the inkjet printhead opposite the first curing unit.

6. The 3D printing apparatus of claim 2, wherein the inkjet printhead comprises a UV-curable binder.

7. The 3D printing apparatus of claim 6, wherein the inkjet printhead is configured to deposit the UV-curable binder based on a position thereof along the first direction.

8. The 3D printing apparatus of claim 1, wherein the powder distributor is mounted on the mounting apparatus adjacent to the inkjet printhead.

9. The 3D printing apparatus of claim 8, wherein two powder distributors are mounted on the mounting apparatus adjacent to the inkjet printhead, the inkjet printhead being between the two powder distributers on the mounting apparatus.

10. The 3D printing apparatus of claim 8, further comprising a second inkjet printhead, wherein the powder distributor is between the first inkjet printhead and the second inkjet printhead.

11. The 3D printing apparatus of claim 10, further comprising:
a third inkjet printhead adjacent the second curing unit; and
a second powder distributor between the second inkjet printhead and the third inkjet printhead.

12. The 3D printing apparatus of claim 1, further comprising a movable shaft configured to move the build platform in a third direction perpendicular to the longitudinal direction.

13. The 3D printing apparatus of claim 1, further comprising a controller configured to synchronize locations of the powder distributor, the inkjet printhead, and the curing unit.

14. The 3D printing apparatus of claim 13, wherein the controller is configured to synchronize the locations of the powder distributor, the inkjet printhead, and the curing unit by varying speed of movements of the powder distributor, the inkjet printhead, and the curing unit to provide adequate time for each of the powder distributor, the inkjet printhead, and the curing unit to perform their respective operations of depositing powder, delivering binder and irradiating the delivered binder in synchronization with one another.

15.-18. (canceled)

19. The apparatus of claim 3, wherein:
the mounting apparatus and the build platform are configured to deposit a first layer of the powder when the one of the mounting apparatus and the build platform moves in the first direction,
the mounting apparatus and the build platform are configured to deposit a second layer of the powder when the one of the mounting apparatus and the build platform moves in the second direction, after the first layer of powder has been deposited, and
the powder distributor, the inkjet printhead and the curing unit operate in synchronization with one another in response to actuation of the powder distributor to begin distributing both the first layer of powder in the first direction and the second layer of powder in the second direction.

20. The apparatus of claim 19, wherein the first layer of powder is comprised of a first type material and the second layer of powder is comprised of a second type material, different from the first type material.

21. The apparatus of claim 3, wherein the powder distributor is separate from the mounting apparatus and is configured to move in the first and second directions and to distribute powder in the first and second directions, separate from, and synchronized with, movement of the one of the mounting apparatus and the building platform in the first and second directions.

22. The apparatus of claim 3, wherein the building platform is a conveyorized printing platform configured to move in the first and second directions while the mounting apparatus remains stationary.

23. The apparatus of claim 3, wherein the mounting apparatus is configured to move in the first and second directions while the building platform remains stationary.

24. The apparatus of claim 3, wherein the one of the mounting apparatus and the build platform that is configured to move in the first and second directions is further configured to move with varying speeds for synchronizing operations of the powder distributor, the printhead and the curing unit in response to actuation of the powder distributor to begin distributing powder.
